(19) United States
(12) Patent Application Publication
(10) Pub. No.: US 2004/0215355 A1
(43) Pub. Date: Oct. 28, 2004

(54) Modular system and method for programming machine automation controls

(76) Inventors: Dean Mills, Paris (CA); Nick Wagner, Kitchener (CA)

Correspondence Address: PERMAN & GREEN, 425 POST ROAD, FAIRFIELD, CT, 06824, US

(21) Appl. No.: 10/618,800

(22) Filed: Jul. 14, 2003

(30) Foreign Application Priority Data
Apr. 25, 2003 (CA) 2,425,719

(51) Int. Cl. G05B 13/02

(52) U.S. Cl. 700/28

(57) ABSTRACT

A modular system and method for programming machine automation controls is disclosed. The system includes a library of minor step modules and a procedure creator for creating a machine automation procedure from an assembly of the minor step modules. The system also includes a product type manager for inputting product parameters independent of the minor step modules, a system configuration manager for defining machine configuration independent of the minor step modules, and an execution engine for calling the procedure and maintaining information flow in and out of the minor step modules.

### FIELD OF THE INVENTION

The present invention relates generally to computer programming techniques and applications, and more particularly to the process control programming of machine automation systems.

### BACKGROUND OF THE INVENTION

Automated systems involve the integration of sub-systems into a working whole, controlled and governed by computer code. Since this controlling computer code is most often created from a library of functions, when equipment from an assortment of vendors is integrated the libraries supplied with individual pieces of equipment regularly follow differing and mostly incompatible design philosophies.

Due to the wide variety of instruments, robots, and other technologies used in automation applications, implementation of expandability and compatibility between otherwise incompatible machines is highly desirable within the controlling software. What is needed is an automation software suite that is capable of controlling machines in a wide variety of industries from automotive assembly systems to fiber optics.

Another problem is that machine sequences are generally “hard-coded” with a very limited number of process parameters, if any, modifiable at runtime. Modifying an on-line machine can be extremely difficult if not impossible. The result is that in order to modify most process parameters, a process must be taken off-line to perform time-consuming, low-level code re-writes by one or more knowledgeable programmers. Subsequently, the rewritten code must be reintroduced to the machine and process, where it must undergo further time consuming code and process integrity testing.

Even off-line changes, such as routine servicing can be difficult, time consuming, and costly when prior art programming methods are employed, often requiring the attention of one or more programmers on-site. To control individual automation machines, custom code has had to be written, often at the Programmable Logic Controller (PLC) level or low-level PC code. Due to this difficult to work with low-level code, the interfacing of multiple instruments, the automation machine, and the product itself can be difficult and cumbersome, leading to a requirement for long development and code writing time when modifying a machine process or designing a new machine.

Compounding the problem is the fact that the source code is often not available from the vendor of the automation program. Even when the source code is available, individual functions are typically subsumed within the source code in a form that resists modification. Individual functions lack embodiment in a single configurable entity from within the whole of the code, so that when attempting to modify one or more parameters of a process, one must hunt through the code to find and edit specific functionality. No method exists for easily reorganizing complete functional blocks of machine automation control sequences. What is needed is a more practical and operator-friendly approach to programming automated machine sequences.

For the foregoing reasons, there is a need for an improved system and method for programming machine automation controls.

### SUMMARY OF THE INVENTION

The present invention is directed to a modular programming system and method for machine automation. The system includes a library of minor step modules and a procedure creator for creating a machine automation procedure from an assembly of the minor step modules. The system further includes a product type manager for inputting product parameters independent of the minor step modules, a system configuration manager for defining machine configuration independent of the minor step modules, and an execution engine for calling the procedure and maintaining information flow in and out of the minor step modules.

In an aspect of the present invention, the system further includes an information center to provide a common screen for output display.

The method includes the steps of providing a library of minor step modules, creating a machine automation procedure from an assembly of the minor step modules, inputting product parameters independent of the minor step modules, and defining machine configuration independent of the minor step modules. The method further includes the steps of calling the procedure and maintaining information flow in and out of the minor step modules.

In an aspect of the present invention, procedures can further include major step modules assembled from a plurality of the minor step modules to perform a larger machine function.

Using the invention, an automation procedure can now be easily modified so that, by using the same core procedure, an automation specialist can quickly re-configure that one procedure to assemble different products on the same assembly machine, or conversely, assemble the same product on a different assembly machine. The invention provides a means to interface multiple instruments or devices, a set of products, and a given assembly machine to bind the product, process, and machine operation into a single development package, therein simplifying the development of automated systems. The invention puts process engineers in control of manufacturing, rather then burdening them with software development, validation, and testing.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

These and other features, aspects, and advantages of the present invention will become better understood with regard to the following description, appended claims, and accompanying drawings where:

FIG. 1 is an overview of a modular system for programming machine automation controls in accordance with an embodiment of the present invention;

FIG. 2 is an overview of a modular method for programming machine automation controls in accordance with an embodiment of the present invention;

FIG. 3a illustrates a procedure creator screen showing a secondary procedure;

FIG. 3b illustrates a procedure creator screen showing a main procedure;

FIG. 4 illustrates a product type manager screen;

FIG. 5 illustrates a system configuration manager screen;

FIG. 6a illustrates an information center screen; and

FIG. 6b illustrates a drill down on a region of interest within the information center.

### DETAILED DESCRIPTION OF THE PRESENTLY PREFERRED EMBODIMENT

The following definitions of terms used in this description are given here for convenience and clarification:

| | |
|---|---|
| Minor Step | Minor step modules 12 are functional blocks of control |
| Module | code embodied in a single configurable entity |
| | dedicated to specific machine functions, and are the |
| | building blocks from which major step modules 24 and |
| | procedures 16 are built. |
| Major Step | Major step modules 24 are assemblages of minor step |
| Module | modules 12 acting in concert to perform a larger |
| | machine function. |
| Procedure | Procedures 16 are assemblages of major 24 and/or |
| | minor step modules 12 acting in concert to perform a |
| | series of machine automation functions. |

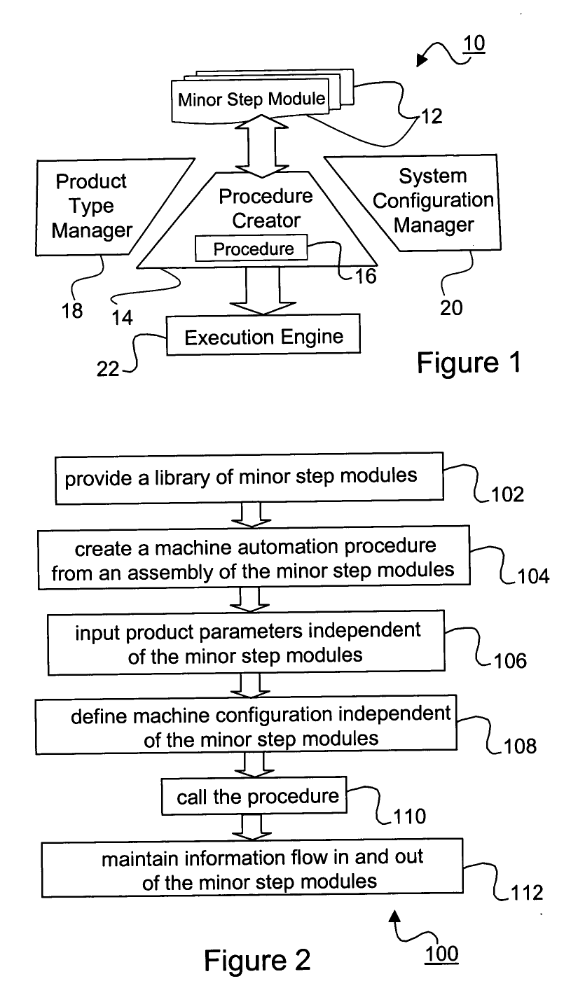

An embodiment of the present invention is directed to a modular system 10 and method 100 for programming machine automation controls. As illustrated in FIG. 1, the system 10 includes a library of minor step modules 12, and a procedure creator 14 for creating a machine automation procedure 16 from an assembly of the minor step modules 12. The system 10 further includes a product type manager 18 for inputting product parameters independent of the minor step modules 12, a system configuration manager 20 for defining machine configuration independent of the minor step modules 12, and an execution engine 22 for calling the procedure 16 and maintaining information flow in and out of the minor step modules 12.

In an embodiment of the present invention, procedures 16 can further include major step modules 24 assembled from a plurality of the minor step modules 12 to perform a larger machine function.

As illustrated in FIG. 2, the method 100 includes the steps of providing a library of minor step modules 102, creating a machine automation procedure from an assembly of the minor step modules 104, inputting product parameters independent of the minor step modules 106, and defining machine configuration independent of the minor step modules 108. The method 100 further includes the steps of calling the procedure 110, and maintaining information flow in and out of the minor step modules 112.

The method employed by the system 10 to control the automated process is realized in code through an architecture that enables the flexible manipulation and control of a machine program at a runtime level of software execution. The modular system's 10 architectural components include minor step modules 12, major step modules 24, procedures 16, the procedure creator 14, the product type manager 18, the system configuration manager 20, and the execution engine 22.

The Minor Step Module 12

Minor step modules 12 are collections of interfaces, each handling a different function with a defined response. All machine functions are handled at the minor step module 12 level. A minor step module 12 is the lowest level of runtime machine control and is an executable entity on its own, independent of any other part of the system 10. Minor step modules 12 are capable of being used multiple times with different parameter sets for each use. Even multiple times within the same major step 24 or procedure 16. Minor step modules 12 are independently testable and contain all driver level software, thereby providing a “brand-transparency” to the operator.

A typical minor step module 12 library may include control functions, dependant on available machine functions, such as motion control, I/O (Input/Output) control, machine vision, and optical instrument control such as an optical spectrum analyzer (OSA), power meter, or tunable laser. A minor step module 12 can perform a host of widely varying actions, from actuating a valve to performing complicated vision analysis, or even sending email. An example of a minor step module 12 is shown in Table 1, which illustrates program code for locating the tip of a contact pin using a process control camera to determine, through vision analysis, its Z-X coordinates prior to active alignment. The result of this step is returned and converted to machine coordinates.

TABLE 1
Complex Minor Step Module 12 Example

Move pin to “camera center point” - X-Z motion
Select camera 3 - Select the correct camera
Acquire image - Take a snapshot image
Find Tip - Command to process image and return data

The structure and requirements for a minor step module 12 are determined by the actions necessary to construct and obtain required results from a procedure 16, and are further defined by the process of the machinery. For the general automation industry, generic minor step modules 12 are structured for meeting common needs to maximize the modularity and reusability of minor step modules 12. For example, when considering a need for waiting 200 milliseconds to allow a mechanical relay to properly close, there are three options for creating an appropriate minor step module 12, each of which is illustrated in Table 2.

TABLE 2
Module Options

| | Option | Discussion |
|---|---|---|
| 1 | Add the delay into the minor | Need to modify an existing minor |
| | step module 12 that outputs the | step that has been already tested |
| | signal to close the relay. | and validated. Adds no new value |
| | | to the library of minor step |
| | | modules 12, except if multiple |
| | | relays require a time delay. |
| 2 | Use the existing minor step | This is similar to Option 1, except |
| | module 12 for outputting the | that the original minor step is |
| | signal to close the relay. Save it | retained, and a new project-specific |
| | under a new name and add the | piece of code is created that may |
| | new code for the time delay | or may not be useable |
| | | in other projects. |
| 3 | Create a new minor step | Requires only a simple minor step |
| | module 12 that provides for a | to be created that is simple to test |
| | programmable delay | and validate. This option adds |
| | | value to future projects because |
| | | of the reusability of this simple |
| | | minor step module 12. |

Table 3 illustrates an example of a small procedure 16 used to test for the presence of bent pins on a connector. An air cylinder is used to engage a connector block onto the pins of the connector under test. The cylinder is provided with sensors at each end of the travel called “Connector Retracted” and “Connector Advanced” sensors, for the retracted and advanced positions of the cylinder respectively. The connector block includes a guard that will prevent the block from connecting to the connector under test if any pins are bent by a prescribed amount. Outputting a digital signal, called “Advance Connector Block”, controls the cylinder.

TABLE 3
Bent Pin Detection Procedure

| | |
|---|---|
| 1. | Wait for start test signal - no timeout (Wait for digital in with |
| | Timeout Minor Step) |
| 2. | Send PC Busy Signal - (Digital Out Minor Step) |
| 3. | Activate Digital Signal “Advance Connector Block” (Digital |
| | out Minor Step) |
| 4. | Wait for “Connector Retracted” sensor to be off and “Connector |
| | Advanced” sensor to be on, OR 2 seconds (Wait for Digital in With |
| | Timeout Minor Step) |
| 5. | If no timeout then continue (IF Minor Step) |
| 6. | Send Test Passed (Digital Out Minor Step) |
| 7. | Else (place holder) |
| 8. | Send bent pin fault (Digital Out Minor Step) |
| 9. | End Else (place holder) |
| 10. | Send Test Complete (Digital Out Minor Step) |

Table 3 demonstrates that, with the high reuse of the “digital out” minor step module 12, only five different minor step modules 12 are used for the ten minor steps in this procedure 16.

The example in Table 3, in conjunction with Table 2 demonstrates how a procedure 16 is executed, and how the functionality of the procedure 16 is far removed from the actual individual minor step modules 12. Once a minor step module 12 is created and debugged, it will work in conjunction with all other minor step modules 12 without a need to test the minor step modules 12 together as group, except to perhaps test the process. The “backend” of a minor step module 12 is tested to work with the execution engine 22.

The modular nature of the minor step module 12 allows for the quick development of any new minor step that may be required, and any subsequent testing of this minor step module 12 can be done independent of any specific project. Once a minor step module 12 is tested and validated, it can be inserted into any procedure 16 with any other minor step modules 12, and be trusted to work properly. In this way, the system 10 differs from other programming languages in that any minor step module 12 can be inserted into any procedure 16 on any project without worrying about introducing new bugs into the execution of that procedure 16.

With other programming languages a function call may call any number of other functions, corrupt memory, change how the executable works, or cause compiler errors that have to be debugged. Even a simple change to insert a new call into an executable will require editing the source code, testing the source code, compiling the code into an executable, testing the executable and then testing the process. It is therefore necessary to only test the process, allowing a process person to do the testing instead of a programmer and a process person.

The Major Step Module 24

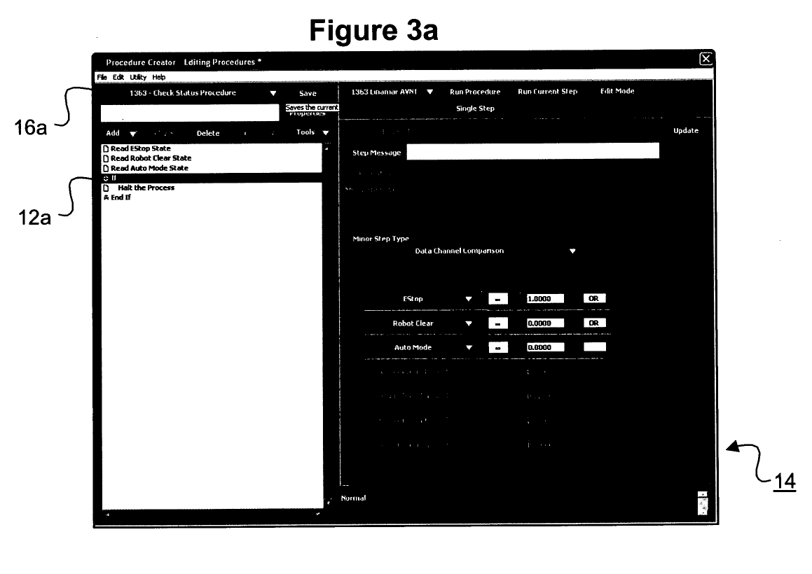

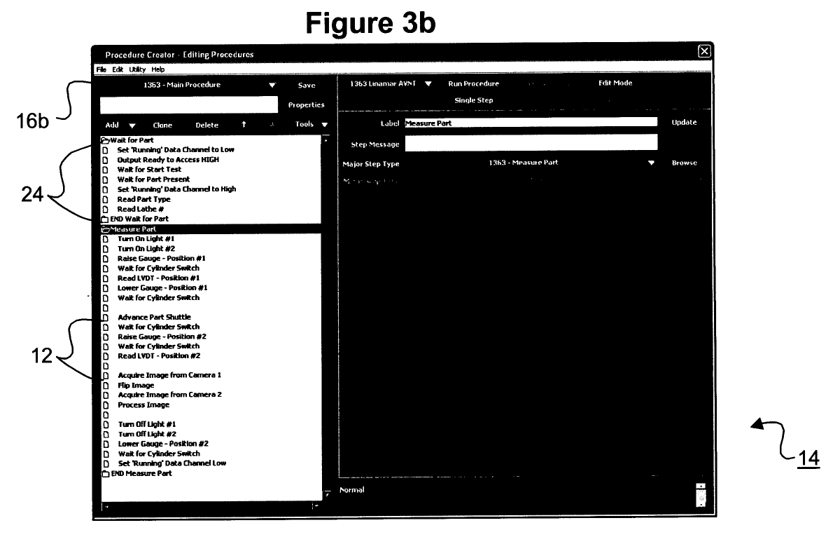

In its simplest form, a major step module 24 is a grouping of minor step modules 12. Major step modules 24 are generally intended for machine level operations, such as moving one axis of a multi-axis system. The design of a major step module 24 facilitates the reuse of collections of minor step modules 12 so that minor step modules 12 can be conveniently grouped for common tasks, such as “Wait for Part” or “Measure Part”, as illustrated in FIG. 3b.

This packaging of common groupings of minor step modules 12 into a major step module 24 enhances the minor step module's 12 reusability and portability, as well as helps simplify writing procedures 16. Although a major step module 24 is similar in appearance to a procedure 16, the execution engine 22 does not directly access major step modules 24 in the same manner as it accesses a procedure 16. Major step modules 24 are instead packaged within an accessed procedure 16.

The Procedure 16

A procedure 16 is a linked and ordered set of major 24 and/or minor step modules 12, as well as ‘IF’ and ‘REPEAT’ statements. Procedures 16 are created using the procedure creator 14, and are used by the execution engine 22 to control or monitor one or more machines. A procedure 16 defines an entire stepwise operation of a machine from start to finish.

The Procedure Creator 14

The procedure creator 14 is a GUI (Graphical User Interface)-based assembly sequence editor used to link steps and data to produce an executable machine process. The procedure creator 14 provides an interface to the operator for the creation of major step modules 24 from minor step modules 12 and ultimately the assembly of entire procedures 16. Using the procedure creator 14 screen, supervisors and engineers can make procedure 16 modifications, and operators can view and run procedures 16.

The procedure creator 14 is used to create major step modules 24 from a library of pre-created minor step modules 12, and to assemble procedures 16 from major step modules 24 and/or minor step modules 12 to create a list of minor step modules 12 that execute in order. By providing standard programming language tools, including recursive looping and “IF-THEN-ELSE” statements, the procedure creator 14 facilitates an indefinite compilation of minor step modules 12 to create a procedure 16. A pseudo-programming language has been implemented to enable the creation of robust, conditional looping procedures. As minor step modules 12 are selected for inclusion in a major step module 24 or procedure 16, relevant settings for each minor step module 12 are maintained, in isolation from any external changes, due to their modular design; thus allowing for the same minor step modules 12 to be reused with varying settings. Procedures 16 can include assembly and monitoring procedures, with operations ranging from the simple to the complex.

The procedure creator 14 enables an operator to create multiple custom assembly procedures 16, either for a single machine or a cluster of machines. As well, multiple procedures 16 can be run in parallel. For example, the ‘Check Status’ “secondary” procedure 16a illustrated in FIG. 3a continuously checks for the presence of signals for ‘Emergency Stop’, ‘Robot Not Clear’, and ‘Change in Operation Mode’. If any of these signals are received, the process is halted. When a minor step module 12 is selected on the left hand side of the screen, in this case the “IF” minor step module 12a, configuration settings can be modified on the right hand side of the screen. This ‘Check Status’ secondary procedure 16a may be advantageously run in parallel with a main procedure 16b such as the one illustrated in FIG. 3b. In this manner, highly sophisticated machine operations can be readily defined and executed.

The main procedure 16b illustrated in FIG. 3b incorporates digital I/O, PLC (Programmable Logic Controller) handshaking, communication with a third-party LVDT (Low Voltage Differential Transducer) controller, and vision acquisition and analysis. The illustrated procedure creator 14 GUI is a prototypical example of the configurability of minor step modules 12.

The output of the procedure creator 14 is a procedure file that is specific to one process. However, this process can be made applicable to multiple products by applying the proper parameters. This enables the construction of clusters and lines of otherwise incompatible machines from different vendors, since the procedure creator 14 will see another machine as just another process to control. Following this one procedure 16, one can easily modify the procedure 16 to assemble different product types on the same assembly machine, or alternatively assemble the same product type on a different assembly machines. Additionally, the procedure creator 14 enables the creation of a procedure 16 that can be executed in a choice of modes including real-time, real-time with breakpoints, or even in a simulation mode on a stand-alone computer.

The Product Type Manager 18

The product type manager 18 is an interface from which product parameters can be easily changed without requiring any modification to the underlying procedure 16, major step modules 24, minor step modules 12, or program code. By accessing the product type manager 18 screen, operators can edit various product types being assembled.

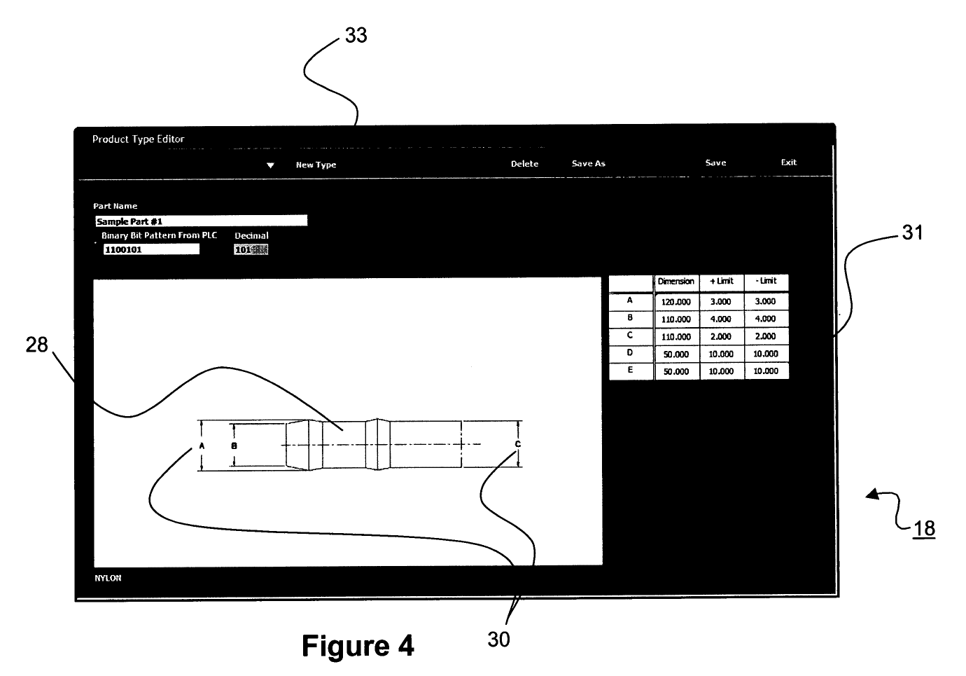

As illustrated in FIG. 4, within the product type manager 18 screen product images 28 are displayed together with associated dimensions 30 that define the process interaction with the product, and consequently the variance parameters between product types. Product parameters can be modified using the parameter table 31 on the product type manager 18 screen. Using the new type button 33, new part configurations can be created and saved.

The product type manager 18 is used to setup part parameters for the process, allowing for easy to modify settings on the part. In an example of a business operating a machine that measures a 1-inch diameter part with a tolerance of +−0002 inches, opening up the tolerance to +−0.004 inches, the only change that is required is the modification of the product type to the new tolerance setting. The procedure 16 will read the new tolerance value and measure based on that new tolerance. The product type manager 18 eliminates the requirement to change the process to reflect a part tolerance change.

The System Configuration Manager 20

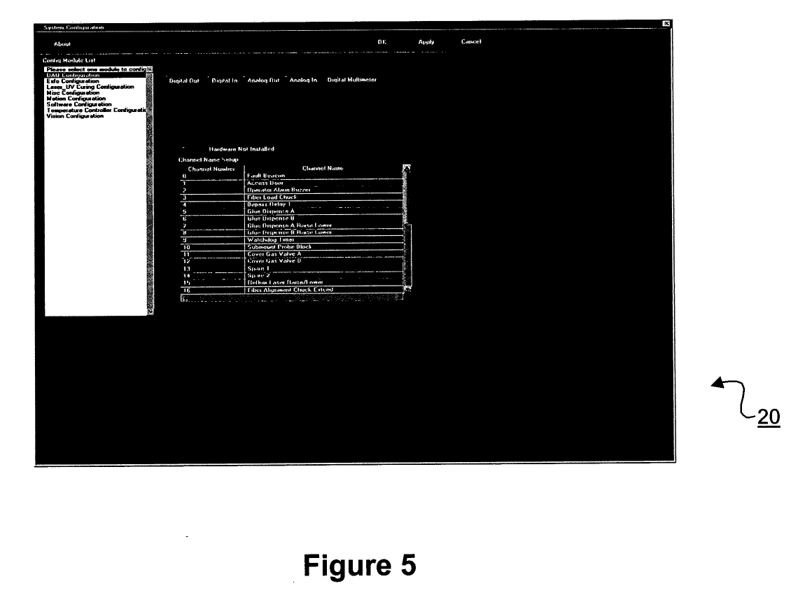

As illustrated in FIG. 5, the system configuration manager 20 is utilized for defining the machine parameters that enable the separation of machine geometry from process creation. A feature of the system configuration manager 20 is a built-in relation of all local coordinate frames to a machine's base coordinate frame. For example, a minor step module 12 can be created for a motion routine based on any local coordinate frame. The system configuration manager 20 will then independently define how this minor step module 12 fits into any given machine.

The system configuration manager 20 acts as a centralized setup screen enabling the customization of any hardware, instrumentation or software configuration setting. For example, an operator can define how many and what types of devices are on a machine, and how they are positioned. The configuration of the automated machine can include configuration data such as type of hardware including machine specific data, instrumentation, taught points, and tool collision avoidance information. Configuration data is maintained and used throughout the system 10 to enable minor step modules 12 to know what hardware is in use and how to communicate with it.

FIG. 5 illustrates the settings of a specific piece of data acquisition hardware. On this screen, the signals wired to the data acquisition device are named and the device is enabled or disabled. Much like the product type manager 18, the system configuration manager 20 allows for modification and configuration of the machine without modifying any minor step modules 12. For example, if the wiring or naming of signals being acquired through hardware devices is changed, in most cases it is only necessary to enter those changes through the system configuration manager 20, with little or no changes required to the procedure 16 or minor step modules 12.

The Execution Engine 22

In the simplest terms, the execution engine 22 executes the automation process based on the procedure 16 generated by the procedure creator 14, and calls the minor step modules 12 found within that procedure 16 to control the automation machine. The execution engine 22 is further responsible for maintaining the flow of information in an out of the various minor step modules 12 called as the procedure 16 executes.

The execution engine 22 performs operations including running major step modules 24 and minor step modules 12, accepting data from outside sources, controlling the machine using the data, running the process using local configurations, passing results to a database and/or supervisory computer, using the local calibration of hardware, and handling fatal errors. Non-fatal errors can be handled by pre-programmed routines in a created procedure 16. However, if specific error handling is not pre-programmed, the execution engine 22 can handle unexpected errors automatically.

The execution engine 22 has been designed specifically for executing modular procedures 16 containing minor step modules 12 in accordance with the system 10. As such, it is highly optimized for executing modular code, with processor threading and parallelism handled automatically. Thus, a machine can execute several procedures in parallel, completely independent or interdependent of each other, employing such features as rendezvous and/or semaphores. Furthermore, minor step modules 12 are preloaded in memory, with capability to embed certain commonly occurring and/or time-critical minor step modules 12 directly into the execution engine 22 for optimum performance.

The Information Center 26

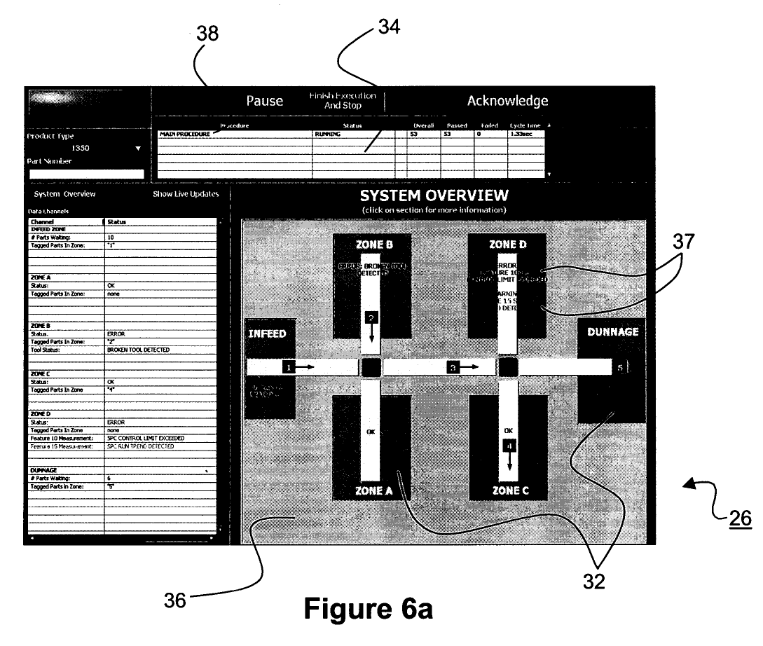

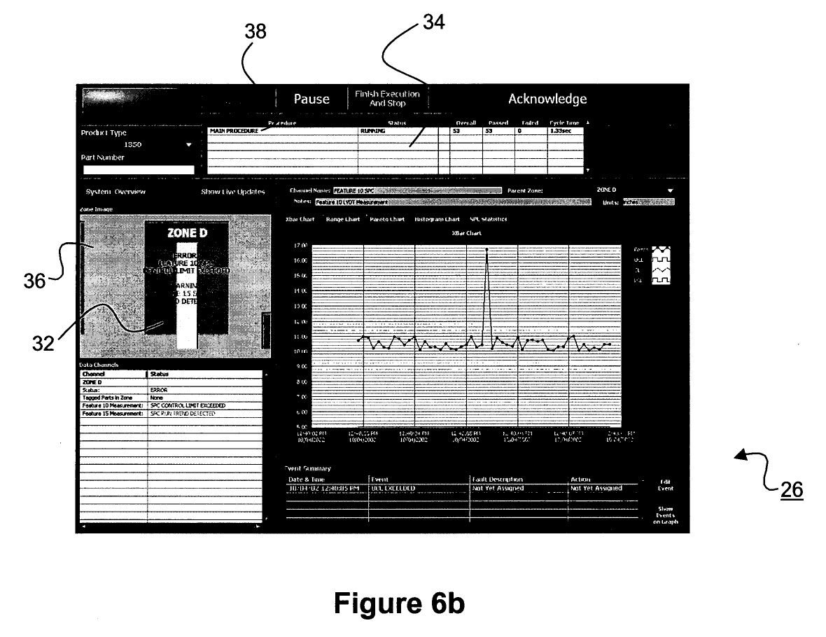

As illustrated in FIGS. 6a and 6b, in an embodiment of the present invention, the system 10 further includes an information center 26 to provide a common screen for displaying outputs. The information center 26 is an interface to the execution engine 22 that provides a place for an operator to view any relevant information in a generic and common screen where all output is presented. Whenever a minor step module 12 outputs status information, this information is displayed in the information center 26 in real time. This common screen contains multiple viewable areas designated for each displayable data type. In addition, the information center 26 can log all data passed to it.

FIG. 6a illustrates an information center 26 as it might appear during a machine operation, with critical information overlaid on a machine overview image 36 representing the machine. Vision, numeric, and status data are all presented graphically. Information about the status of all procedures 16 is displayed in a procedure table 34 in the top center area of the screen, with errors and warnings along with other status updates overlaid on the machine overview image 36 in coded colors 37. Additional detailed information can be obtained by drilling down on the overview image 36, or a procedure listing 38 in the procedure table 34, as illustrated in FIG. 6b. When an operator clicks on a particular Region of Interest (ROI) 32, the system 10 will drill down to display zone information for the appropriate zone.

The system 10 is intended for the control of automation in areas including machinery, manufacturing processes, test and supervisory systems, automated machinery integration processes, machine vision, motion control, device control, instrument control, automated testing, and network and bus control for communications internal and external to a central controller.

An automated application is generally comprised of three major elements, including the configuration of the automated machine, the configuration of the product type, and creation of the procedure. Configuration of the automated machine incorporates the geometric configuration of mechanical hardware, and the type and number of devices within the machine. Configuration of the product type includes geometry, characteristics and test limits. Thirdly, the creation of the procedure defines the automated process. These three elements: machine, product, and procedure, are manageable elements that together define a complete and functioning automated application. The system 10 provides an operator with an ability to independently modify and develop all three elements, all while the control program is executing.

Since product types may differ only by dimension, the system 10 keeps assembly procedures and product types separate, with assembly procedures remaining the same across a family of products. This provides much greater flexibility within the system 10, eliminating many of the repetitive tasks that have been traditionally associated with changing product types. The design also enables the system 10 to operate over multiple platforms in a line control application, or multiple machines working in parallel to perform similar operations. Otherwise incompatible systems can now be made to operate in a line or a cluster using a common software platform, with one or more of these machines used to supervise and control the line.

The servicing of an assembly machine no longer requires the presence of programmers on-site. Changes can now be made easily, often via telephone support. As well, since the system 10 is customizable and modular, it is able to control machine hardware from many different vendors, without requiring the use of mandated vendor-specific parts.

The system 10 is designed to make configuration simple to the operator by using standardized software modules designed to run on a standard PC platform. Process files can then be shared between machines doing similar operations. Machine sequence and product parameters are independent to the operator. Operators no longer need concern themselves with machine geometry or configuration, since all parameters are now based on a local coordinate frame. New machine development can now take place in the realm of high-level module configuration rather than low-level software development.

By separating machine layout from product definition, and both from the procedure definition, the system 10 reduces the level of comprehension required to create or modify the functionality of any automated system. An operator does not have to think about how to combine an entire process into one program. Process information is now de-coupled from product information, providing greater flexibility and improved performance. A machine process can now be designed or modified by a non-programmer operator such as an automation technician. By facilitating the reuse of procedures, significant cost savings can be realized through, for example, the re-use of processes by a business that has several assembly machines with only minor parameter differences. The system 10 provides a capability to perform all machine programming at runtime. The modular nature of the system 10 enables non-programmers to quickly design and build an entirely new procedure 16 in a fraction of the time previously required for such a task.

Using the system 10, an automation procedure 16 can now be easily modified so that, by using the same core procedure 16, an automation specialist can quickly re-configure that one procedure 16 to assemble different products on the same assembly machine, or conversely, assemble the same product on a different assembly machine. The system 10 provides a means to interface multiple instruments or devices, a set of products, and a given assembly machine to bind the product, process, and machine operation into a single development package, thereby simplifying the development of automated systems. The system 10 puts process engineers in control of manufacturing, rather than burdening them with software development, validation and testing.

Although the present invention has been described in considerable detail with reference to certain preferred embodiments thereof, other versions are possible. Therefore, the spirit and scope of the appended claims should not be limited to the description of the preferred embodiments contained herein.

What is claimed is:

1. A modular system for programming machine automation controls, comprising:
a library of minor step modules;
a procedure creator for creating a machine automation procedure from an assembly of said minor step modules;
a product type manager for inputting product parameters independent of said minor step modules;
a system configuration manager for defining machine configuration independent of said minor step modules; and
an execution engine for calling said procedure and maintaining information flow in and out of said minor step modules.

2. The system according to claim 1, wherein procedures can further include major step modules assembled from a plurality of said minor step modules to perform a larger machine function.

3. The system according to claim 2, wherein procedures are created from one or more components selected from the group consisting of major step, minor step, repeat, and if statement.

4. The system according to claim 1, further including an information center to provide a common screen for output display.

5. The system according to claim 1, wherein security can be set to a plurality of access levels by leveraging an existing security model to provide full access to some, while limiting access to others.

6. The system according to claim 1, wherein one or more minor step modules are directly embedded within the execution engine for improved performance.

7. A modular method for programming machine automation controls, comprising the steps of:
(i) providing a library of minor step modules;
(ii) creating a machine automation procedure from an assembly of said minor step modules;
(iii) inputting product parameters independent of said minor step modules;
(iv) defining machine configuration independent of said minor step modules;
(v) calling said procedure; and
(vi) maintaining information flow in and out of said minor step modules.

8. The method according to claim 6, further including the step of assembling major step modules from a plurality of said minor step modules to perform a larger machine function within said procedure.

9. A modular system for programming machine automation controls, comprising:
a module for providing a library of minor step modules;
a module for creating a machine automation procedure from an assembly of said minor step modules;
a module for inputting product parameters independent of said minor step modules;
a module for defining machine configuration independent of said minor step modules;
a module for calling said procedure; and
a module for maintaining information flow in and out of said minor step modules.

10. A storage medium readable by a computer encoding a computer process to provide a modular method for programming machine automation controls, the computer process comprising:
a processing portion for providing a library of minor step modules;
a processing portion for creating a machine automation procedure from an assembly of said minor step modules;
a processing portion for inputting product parameters independent of said minor step modules;
a processing portion for defining machine configuration independent of said minor step modules;
a processing portion for calling said procedure; and
a processing portion for maintaining information flow in and out of said minor step modules.
